(19) United States
(12) Patent Application Publication
(10) Pub. No.: US 2005/0179712 A1
(43) Pub. Date: Aug. 18, 2005

(54) PRINTING SYSTEM AND RELATED CALIBRATION METHODS

(76) Inventor: Cheng-Lung Lee, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/906,070

(22) Filed: Feb. 2, 2005

(30) Foreign Application Priority Data
Feb. 17, 2004 (TW) 093103753

(51) Int. Cl. B41J 2/195

(52) U.S. Cl. 347/8; 347/7

(57) ABSTRACT

A printing system includes at least one kind of ink, at least one ink jet chip having a plurality of ink nozzles for ink jet printing, a thermometer for measuring an operating temperature of the ink jet chip, a logic unit for generating a calibration instruction for calibrating a jet printing of ink in the printing system according to the operating temperature, and at least one calibration device for calibrating the jet printing of ink in a printing system according to the calibration instruction.

### BACKGROUND OF INVENTION

1. Field of the Invention

The present invention relates to a printing system and related methods for calibration, and more particularly, to a printing system and related methods capable of calibrating printing errors due to different drop velocities of different kinds of ink.

2. Description of the Prior Art

The technology of ink jet printing is applied broadly and the improvement is mature. Printing devices in computer systems, plotters, copiers and fax machines are examples of devices that utilize the technology of ink jet printing to generate hard copies. In general, ink jet printers utilize ink of four colors (cyan, magenta, yellow and black) for printing color images. Printers of high quality can utilize ink of six colors (cyan, magenta, yellow, black, light cyan and light magenta) for printing. Most ink jet printers locate the ink of these different colors in two or more ink guns. There are ink nozzles on each ink gun for spurting out ink by thermal bubbles or piezoelectric action. A carrier of the ink guns is driven to slide on paper by a motor included in the printer, and therefore the ink nozzles are capable of printing a swath of ink onto the paper as the carrier slides over the paper. The motor further advances the paper in a direction perpendicular to a rail along which the carrier slides. Accordingly, the ink nozzles are capable of printing a next swath of ink onto the paper as the carrier slides over the paper. By repeating the aforementioned steps, a document or a picture can be printed.

A pixel is constituted by a plurality of ink droplets of different colors. The volume of each ink droplet is about several pico-liters. The average distance between two pixels is about one six hundredth of an inch. The quality of ink jet printers depends on whether ink droplets are printed to the medium precisely. For color ink jet printing, ink droplets of different colors have to be printed on a same pixel. Therefore the requirement of the accuracy of printing increases. There are a lot of factors in the accuracy of printing. The precision of the ink nozzles, the stability of the sliding speed of the carrier, and the drop times of droplets of different kinds of ink from the ink nozzles to the medium all influence the accuracy of ink jet printing. The drop time of ink droplets is related to the distance from the ink nozzles to the medium and the drop velocity of ink droplets. The drop velocity of ink droplets relies on physical properties of the ink, the input power of the ink guns, and the operating conditions of the ink guns, such as the operating temperature. Please refer to FIG. 1. FIG. 1 is a diagram of a prior art carriage 10 printing ink droplets of different kinds of ink. Ink C1, C2 and C3 are three kinds of ink, each of which has a different drop velocity. Ink nozzle 12, 13 and 14 are ink nozzles for printing ink C1, C2 and C3 respectively. M1 is a medium being printed to. 15, 16 and 17 are ink droplets of ink C1, C2 and C3 printed from ink nozzle 12, 13 and 14 respectively. For instance, assume that under a temperature T1, the drop velocities of ink C1, C2 and C3 are 6 meters per second (m/s), 8 m/s and 10 m/s respectively, the separation between the ink nozzles and the medium M1 is two millimeters (mm) (all other factors relating to the ink are the same), and the sliding velocity of the carriage 10 is 2 m/s. When the operating temperature is T1, the ink droplets 15, 16 and 17 are printed onto the medium M1 0.66 mm, 0.5 mm and 0.4 mm away from their target locations respectively. That means, when droplets of ink C1, C2 and C3 are printed to the same point on the medium, the droplet of ink C1 is 0.26 mm apart from the droplet of ink C3, the droplet of ink C2 is 0.1 mm apart from the droplet of ink C3, and the droplet of ink C1 is 0.16 mm apart from the droplet of ink C2. Obviously, there is an error in printing data.

The relationship between the drop velocity of ink and the temperature may be determined by experiment. Please refer to FIG. 2. FIG. 2 is a graph of drop velocity versus temperature. In FIG. 2, the transverse axis represents temperature, and the vertical axis represents ink drop velocity. Curves 21, 22 and 23 show the relationships between drop velocity versus temperature for typical yellow ink, magenta ink and cyan ink respectively. As shown in FIG. 2, the ratios of velocity among different kinds of ink are various under different temperatures. However, the operating temperature of the inkjet chip increases with the time of printing. Hence there can be an error in printing when the ink jet printer prints data under different operating temperatures, more so if the printer is calibrated under a certain operating temperature.

There are many methods for calibration. These conventional methods are mostly for calibrating errors produced by the ink nozzles, such as calibrating the error between color ink nozzles and black ink nozzles and the two-way error of ink nozzles. However, there is no calibration scheme for calibrating errors due to different drop velocities of different kinds of ink.

### SUMMARY OF INVENTION

It is therefore a primary objective of the claimed invention to provide a printing system that can calibrate errors due to different drop velocities of different kinds of ink.

Briefly described, the claimed invention discloses a printing system capable of calibrating errors due to different drop velocities of different kinds of ink. The printing system includes at least one kind of ink, at least one ink jet chip comprising a plurality of ink nozzles for ink jet printing, a thermometer for measuring an operating temperature of the ink jet chip, a logic unit for generating a calibration instruction for calibrating a jet printing of ink in the printing system according to the operating temperature, and at least one calibration device for calibrating the jet printing of ink in a printing system according to the calibration instruction.

The claimed invention further discloses another printing system capable of calibrating errors due to different drop velocities of different kinds of ink. The printing system includes a paper module for conveying a medium, at least one kind of ink, and at least one ink jet chip comprising a plurality of ink nozzles for ink jet printing on the medium, wherein distances between the paper module and the plurality of ink nozzles are different from one another.

The claimed invention further discloses a method for calibrating jet printing of ink in a printing system, wherein the printing system includes a thermometer, a paper module for conveying a medium, at least one kind of ink, and at least one ink jet chip, the ink jet chip comprising a plurality of ink nozzles for ink jet printing on the medium. The method includes adjusting distances between each ink nozzle and the paper module according to a drop velocity of the ink under a predetermined temperature.

The claimed invention further discloses another method for calibrating jet printing of ink in a printing system, wherein the printing system includes a thermometer, at least one kind of ink, and at least one ink jet chip, the ink jet chip comprising a plurality of ink nozzles for ink jet printing. The method includes measuring an operating temperature of the ink jet chip by the thermometer when the printing system prints data, and adjusting time delays of trigger signals of the plurality of ink nozzles according to the operating temperature.

It is an advantage of the claimed invention that measurement of the operating temperature and knowledge of the drop velocities of different kinds of ink under different operating temperature help calibrating printing errors. In the claimed invention, the operating temperature of the inkjet chip is measured when the printing system prints data, and the time delays of trigger signals of the plurality of ink nozzles and the data shift parameters are adjusted according to the measured temperature. Therefore the errors due to different drop velocities are calibrated against.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior art carriage printing ink droplets of different kinds of ink.

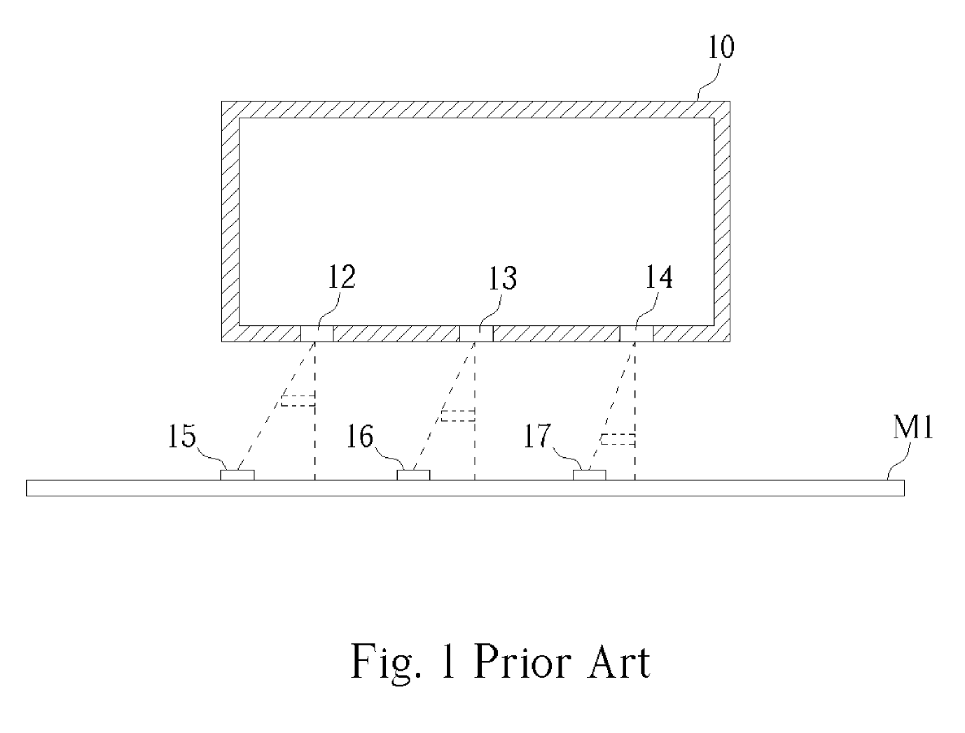

FIG. 2 is a graph of drop velocity versus temperature.

FIG. 3 is a diagram of the present invention carriage printing ink droplets of different kinds of ink.

FIG. 4 is a diagram of a testing chart.

FIG. 5 is a diagram of an actual printed chart when printing the testing chart shown in FIG. 4.

FIG. 6 is a diagram of a first embodiment of the present invention testing page.

FIG. 7 is a flowchart of the present invention method of calibrating jet printing of ink in a printing system.

### DETAILED DESCRIPTION

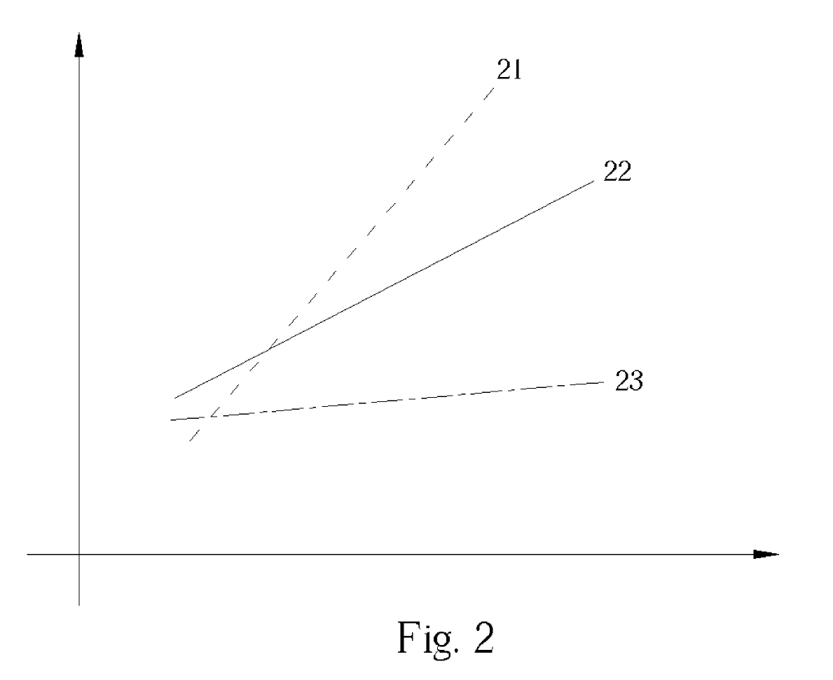

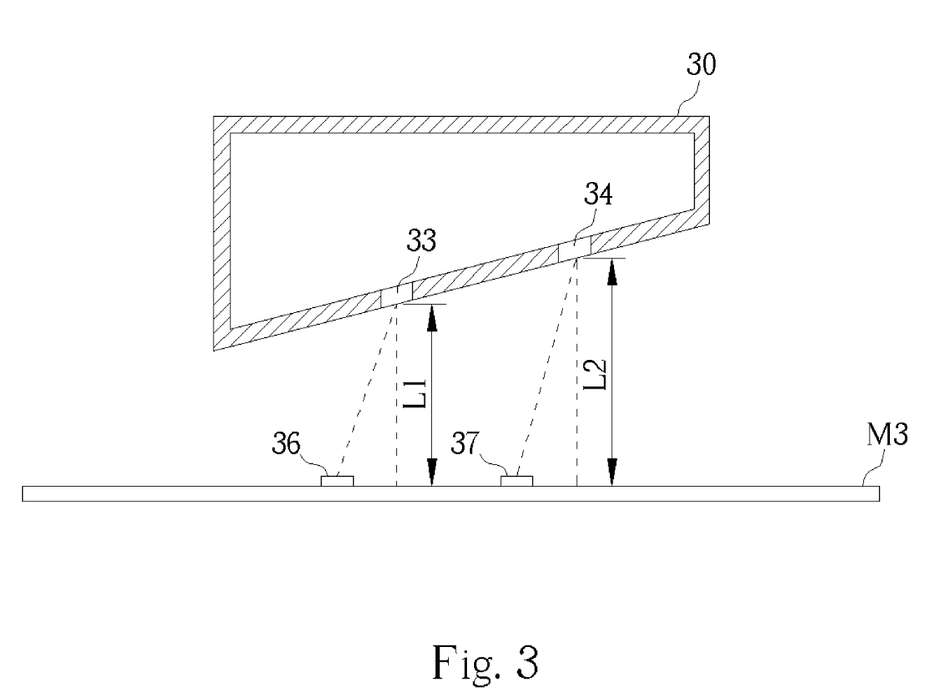

Relations of drop velocity of ink versus operating temperature as shown in FIG. 2 can be obtained by experiment. The claimed invention utilizes these known relations to decide locations of each ink nozzle according to the drop velocity of each kind of ink under a predetermined temperature in order to calibrate errors due to different drop velocities. The predetermined temperature should be chosen within a reasonable rage of operating temperature. Please refer to FIG. 3. FIG. 3 is a diagram of the present invention carriage 30 printing ink droplets of different kinds of ink. An ink jet chip on the carriage 30 is capable of printing two kinds of ink, C2 and C3. M3 is a medium being printed to. 36 and 37 are ink droplets of ink C2 and C3 printed from ink nozzle 33 and 34 respectively. L1 is the distance from the ink nozzle 33 to the medium M3, and L2 is the distance from the ink nozzle 34 to the medium M3. As aforementioned, assume that under a predetermined temperature, say, 30 degrees centigrade, the drop velocities of ink C2 and C3 are 8 m/s and 10 m/s respectively. Accordingly, L1 and L2 are designed as 1.6 mm and 2 mm respectively. Assuming the sliding velocity of the carriage 30 is 2 m/s, when the operating temperature is 30 degrees centigrade, the ink droplet 36 and 37 are both printed onto the medium M3 0.4 mm away from directly below the nozzles 33 and 34. This shows that when ink droplets of ink C2 and C3 are printed to the same point on the medium, the present invention is capable of printing the ink droplets of ink C2 and C3 to the same point precisely.

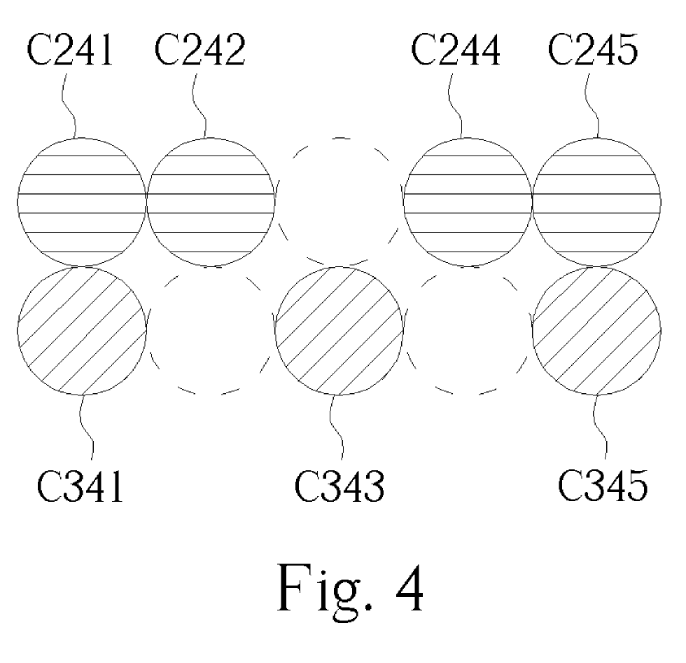

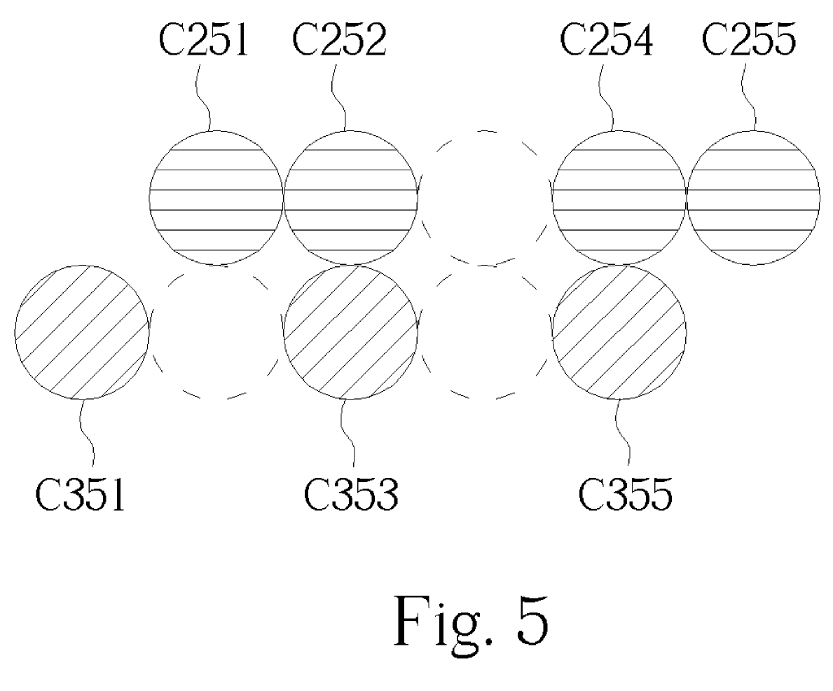

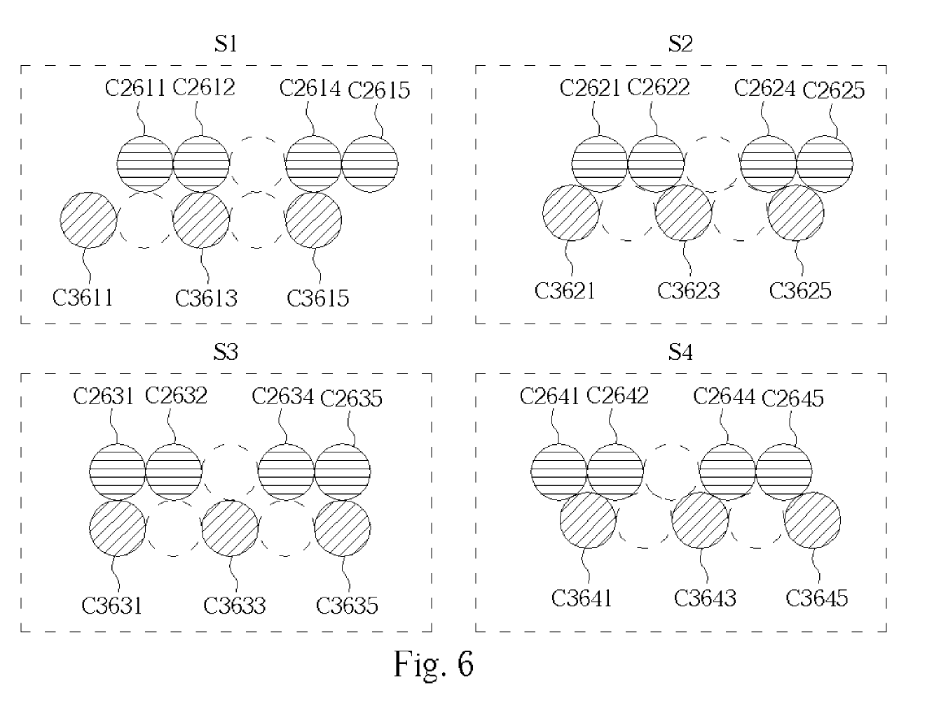

The ink jet chip is designed according to the drop velocities of ink under a certain temperature. However, the drop velocities change during a printing task because the operating temperature of the ink jet chip increases as the time of successive printing accumulates. In the present invention printing system, there are further calibration methods for calibrating errors due to the changing operating temperature of the ink jet chip. The printing system further includes a thermometer for measuring the operating temperature of the ink jet chip. The thermometer may be located on the ink jet chip. In the present printing system, the thermometer measures the operating temperature of the ink jet chip when the printing system prints data and therefore the data to be printed can be adjusted and calibrated. The present invention printing system may print a testing chart for calibration as conventional printing systems do. Please refer to FIG. 4. FIG. 4 is a diagram of a testing chart to be printed by the claimed printing system. Data C241, C242, C244 and C245 are data of ink C2, and data C341, C343 and C345 are data of ink C3. Though the ink jet chips included in the printing system are to be suitably designed, there is still inaccuracy resulting from handling and manufacturing concerns when the systems leave the factory, or resulting from inconsistent operating temperature. Hence the actual printed testing chart may be different from the chart in FIG. 4, for instance, such as FIG. 5. Data C251, C252, C254 and C255 are data of ink C2, and data C351, C353 and C355 are data of ink C3. As shown in FIG. 5, the arrangement of data C251, C252, C254, C255, C351, C353 and C355 is not equivalent to the arrangement illustrated in FIG. 4, which means there is some error. According to the present invention method, when the printing system prints data, a predetermined testing page may be printed so the operating temperature can be measured in advance. The testing page includes a plurality of testing charts. Each testing chart is printed with a corresponding set of time delays of trigger signals and data shift parameters. By delaying the time of trigger signals, the locations onto which the ink droplets are printed can be adjusted and calibrated. Additionally, the data shift parameters are capable of shifting the data to be printed for compensating the errors before the ink nozzles print out the droplets of ink. Please refer to FIG. 6. FIG. 6 is a diagram of a first embodiment of the present invention testing page. S1, S2, S3 and S4 are four testing charts printed with an individual set of time delays of trigger signals and data shift parameters. Data C2611, C2612, C2614, C2615, C2621, C2622, C2624, C2625, C2631, C2632, C2634, C2635, C2641, C2642, C2644 and C2645 are data of ink C2, and data C3611, C3613, C3615, C3621, C3623, C3625, C3631, C3633, C3635, C3641, C3643 and C3645 are data of ink C3. Assume that the operating temperature of the ink jet chip is 34 degrees centigrade when printing the testing page, the data shift parameter of data of ink C2 is 0, the time delay of trigger signals of data of ink C2 is 0, the data shift parameter of data of ink C3 in the testing chart S1, S2, S3 and S4 are 0, 1, 1 and 1 respectively, and the time delay of trigger signals of data of ink C3 in the testing chart S1, S2, S3 and S4 are 0, 0, 1 and 2 respectively. In the present invention method, the printed testing page is scanned and the scanned data is processed. In this example, it is determined that the testing chart S3 is the most precise one among the four testing charts. Therefore, the data shift parameter of data and the time delay of trigger signals of ink C2 and C3 are adjusted to the settings with which the testing chart S3 was printed.

After the aforementioned calibration, when the present printing system prints data, the operating temperature of the inkjet chip is automatically measured periodically (according to a predetermined duration), such as every one third of a second. The time delays of trigger signals can be dynamically adjusted according to each measurement of the operating temperature of the ink jet chip and the known influence upon the drop velocities of ink, even during the printing. Relatively, the data shift parameters can only be set in advance to the data being printed. Following the example described above, that is, the data shift parameters of ink C2 and C3 are set to 0 and 1, and the time delays of trigger signals of ink C2 and C3 are set to 0 and 1 respectively. However, the operating temperature is measured as 36 degrees centigrade rather than 34 degrees centigrade when the printing system is about to start to print. According to the knowledge of the drop velocities of the ink, the data shift parameter of ink C3 is changed to 0.75, and the time delay of trigger signals of ink C3 is kept as is. When the printing system starts to print and the predetermined duration, that is, one third of a second passes, the operating temperature of the ink jet chip is measured again automatically. This time, it is found that the operating temperature has risen to 37 degrees centigrade. Since the data is already being printed and cannot be shifted anymore, the time delay of trigger signals of ink C2 and ink C3 are adjusted according to the ratios of the drop velocities under 36 degrees centigrade to 37 degrees centigrade. As explained before, the operating temperature of the inkjet chip increases as the time of successive printing accumulates. Therefore the present printing system is designed to measure the operating temperature and adjust the time delays of trigger signals every predetermined duration.

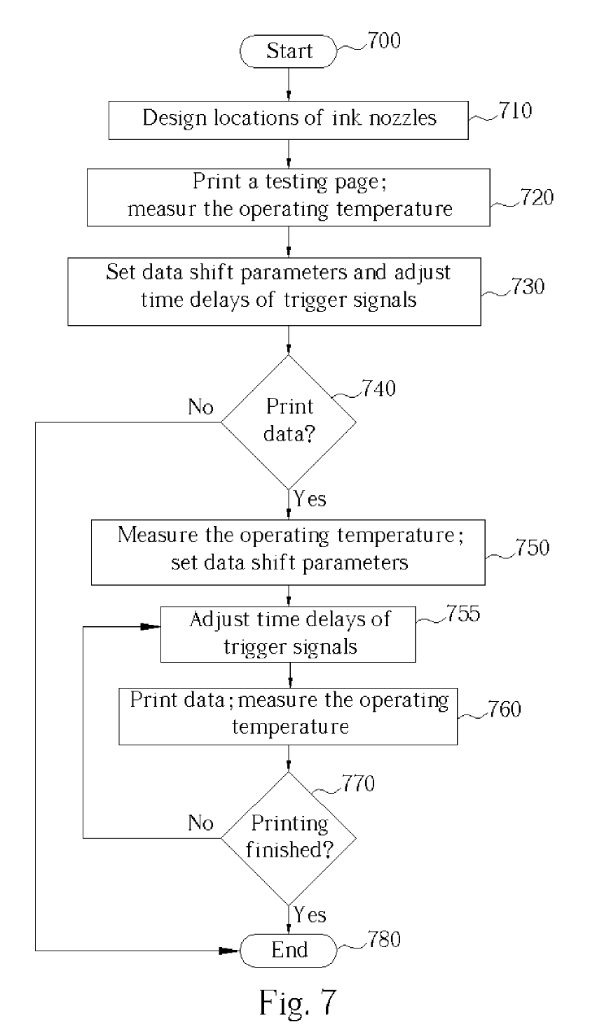

Please refer to FIG. 7. FIG. 7 is a flowchart of the present invention method of calibrating jet printing of ink in a printing system.

Step 700: Start;

Step 710: Design locations of ink nozzles according to drop velocities of ink under a predetermined temperature;

Step 720: Print a predetermined testing page and measuring the operating temperature of the ink jet chip;

Step 730: Set data shift parameters and adjust time delays of trigger signals according to the printed testing page;

Step 740: If there is a printing command, go to step 750; otherwise go to step 780;

Step 750: Measure the operating temperature of the ink jet chip and adjust time delays of trigger signals accordingly;

Step 755: Adjust time delays of trigger signals according to the measured operating temperature;

Step 760: Print data; measure the operating temperature of the ink jet chip after a predetermined period;

Step 770: If the print is completed, go to step 780; otherwise go to step 755;

Step 780: End.

In the above flowchart, step 710 has to be performed before the printer leaves the factory while other steps can be performed repeatedly after leaving the factory in order to calibrate the printing operations whenever needed. The present invention printing system may be designed to automatically perform step 720 whenever the power of the printing system is turned on, or whenever a command is issued by a user. The testing page can be scanned by a scanner, and the most appropriate set of data shift parameters and time delays of trigger signals is therefore chosen according to the result of processing the scanned data. Otherwise, decisions about the setting of data shift parameters and time delays of trigger signals can be made according to estimations made by a user evaluating the testing page with the naked eye.

The claimed method can be applied to calibrate both printing of ink nozzles on the same ink jet chip and printing of ink nozzles on a plurality of ink jet chips for balancing errors due to unequal drop velocities under different operating temperatures. The design of the locations of the ink nozzles may bring up a preliminary compensation for disparate drop velocities under a reasonable predetermined operating temperature. For further calibration, a testing page including a plurality of testing charts with different sets of data shift parameters and time delays of trigger signals may be printed by the present invention printing system. The operating temperature of the ink jet chip is measured when the testing page is being printed, and the data of the testing page is processed. Then, the settings of data shift parameters and time delays of trigger signals are chosen according to the results of the processing. After the initial data shift parameters and time delays of trigger signals are set, when the present printer prints data, the operating temperature of the inkjet chip is measured and the data shift parameters and time delays of trigger signals are adjusted according to the measurement with the knowledge of the relations of drop velocities of ink versus the operating temperature. The preliminary calibration, that is, the design of the locations of the ink nozzles, may be omitted, and the adjustments of the data shift parameters and time delays of trigger signals can be utilized directly for calibrating printing errors.

The present invention provides a printing system and related methods for calibrating jet printing of ink in a printing system. The method is not only capable of initially calibrating printing errors due to different drop velocities of different kinds of ink by compensating for the locations of ink nozzles before the printing system leaves the factory, but is also capable of calibrating printing errors due to unequal drop velocities under different operating temperatures by adjusting data shift parameters and time delays of trigger signals after the printing system leaves the factory. In contrast to the prior art, the present invention printing system and related methods solve the problems resulting from different physical properties of the different kinds of ink that are utilized at the same time. Hence the present invention helps to improve the quality of printing.

Those skilled in the art will readily observe that numerous modifications and alterations of the device may be made while retaining the teachings of the invention. Accordingly, the above disclosure should be construed as limited only by the metes and bounds of the appended claims.

1. A method for calibrating jet printing of ink in a printing system, wherein the printing system comprises a thermometer, a paper module for conveying a medium, at least one kind of ink, and at least one ink jet chip, the ink jet chip comprising a plurality of ink nozzles for ink jet printing on the medium, the method comprising:
adjusting distances between each ink nozzle and the paper module according to a drop velocity of the ink under a predetermined temperature.

2. The method of claim 1 further comprising:
printing a predetermined testing chart;
measuring an operating temperature of the ink jet chip; and
setting data shift parameters of the plurality of ink nozzles according to the testing chart.

3. The method of claim 2 further comprising when the printing system is turned on, automatically printing the predetermined testing chart, measuring the operating temperature of the ink jet chip, and setting the data shift parameters of the plurality of ink nozzles according to the testing chart.

4. The method of claim 2 further comprising adjusting time delays of trigger signals of the plurality of ink nozzles according to the printed testing chart.

5. The method of claim 2 in which the printing system further comprises a scanner, wherein the data shift parameters of the plurality of ink nozzles are set respectively according to a result of processing data of the testing chart scanned by the scanner.

6. The method of claim 1 in which the ink jet chip is utilized for printing a plurality of kinds of ink, the distances between ink nozzles of the plurality of kinds of ink and the paper module are adjusted according to the drop velocities of the plurality of kinds of ink respectively under a predetermined temperature.

7. The method of claim 6 in which the plurality of kinds of ink are of a plurality of colors.

8. The method of claim 1 further comprising:
measuring an operating temperature of the ink jet chip when the printing system prints data; and
adjusting time delays of trigger signals of the plurality of ink nozzles according to the operating temperature.

9. The method of claim 8 further comprising setting data shift parameters of the plurality of ink nozzles according to the operating temperature.

10. The method of claim 1 wherein at least one ink jet chip is capable of printing a plurality of kinds of ink.

11. The method of claim 1 wherein at least one ink jet chip is capable of printing a single kind of ink.

12. A method for calibrating jet printing of ink in a printing system, wherein the printing system comprises a thermometer, at least one kind of ink, and at least one ink jet chip, the ink jet chip comprising a plurality of ink nozzles for ink jet printing, the method comprising:
measuring an operating temperature of the ink jet chip by the thermometer when the printing system prints data; and
adjusting time delays of trigger signals of the plurality of ink nozzles according to the operating temperature.

13. The method of claim 12 further comprising:
printing a predetermined testing chart;
measuring an operating temperature of the ink jet chip; and
setting data shift parameters of the plurality of ink nozzles according to the testing chart.

14. The method of claim 13 in which the printing system further comprises a scanner, wherein the data shift parameters of the plurality of ink nozzles are set respectively according to a result of processing data of the testing chart scanned by the scanner.

15. The method of claim 13 further comprising adjusting time delays of trigger signals of the plurality of ink nozzles according to the printed testing chart.

16. The method of claim 13 further comprising when the printing system is turned on, automatically printing the predetermined testing chart, measuring the operating temperature of the ink jet chip, and setting the data shift parameters of the plurality of ink nozzles according to the testing chart.

17. The method of claim 12 wherein at least one ink jet chip is capable of printing a plurality of kinds of ink.

18. The method of claim 12 wherein at least one ink jet chip is capable of printing a single kind of ink.

19. A printing system comprising:
at least one kind of ink;
at least one ink jet chip comprising a plurality of ink nozzles for ink jet printing;
a thermometer for measuring an operating temperature of the ink jet chip;
a logic unit for generating a calibration instruction for calibrating a jet printing of ink in the printing system according to the operating temperature; and
at least one calibration device for calibrating the jet printing of ink in a printing system according to the calibration instruction.

20. The printing system of claim 19 wherein the calibration device is capable of setting data shift parameters of the plurality of ink nozzles.

21. The printing system of claim 19 wherein the calibration device is capable of adjusting time delays of trigger signals of the plurality of ink nozzles.

22. The printing system of claim 19 wherein the logic unit generates the calibration instruction further according to a testing chart printed by the printing system.

23. The printing system of claim 19 further comprising a scanner capable of scanning a testing chart printed by the printing system, wherein the logic unit generates the calibration instruction further according to a result of scanning the testing chart by the scanner.

24. The printing system of claim 19 wherein the thermometer is located on the ink jet chip.

25. The printing system of claim 19 wherein at least one inkjet chip is capable of printing a plurality of kinds of ink and the calibration device is capable of calibrating a printing of the plurality of kinds of ink printed by the ink jet chip.

26. The printing system of claim 19 wherein at least one ink jet chip is capable of printing a single kind of ink and the calibration device is capable of calibrating a printing by the plurality of ink nozzles of the ink jet chip.

27. A printing system comprising:
a paper module for conveying a medium;
at least one kind of ink; and
at least one ink jet chip comprising a plurality of ink nozzles for ink jet printing on the medium, wherein distances between the paper module and the plurality of ink nozzles are different from one another.

28. The printing system of claim 27 wherein the distances between the paper module and the plurality of ink nozzles are decided according to a drop velocity of the at least one kind of ink under a predetermined temperature.

29. The printing system of claim 27 in which at least one ink jet chip is capable of ink jet printing a plurality of kinds of ink, wherein the distances between the paper module and the ink nozzles of the plurality of kinds of ink are different from one another.
